(19) United States
(12) Patent Application Publication
(10) Pub. No.: US 2023/0231446 A1
(43) Pub. Date: Jul. 20, 2023

(54) MOTOR

(71) Applicant: NIDEC COPAL CORPORATION, Tokyo (JP)

(72) Inventor: Hironori RENGI, Tokyo (JP)

(21) Appl. No.: 18/156,389

(22) Filed: Jan. 19, 2023

(30) Foreign Application Priority Data
Jan. 20, 2022 (JP) 2022-007185

(51) Int. Cl. H02K 11/215; H02K 21/16

(52) U.S. Cl. CPC H02K 11/215; H02K 21/16

(57) ABSTRACT

A motor improves the accuracy of position estimation of a rotor. The rotor included in the motor includes a rotor core containing a magnetic material, a plurality of magnets located on the rotor core in a rotation direction of the rotor, and a plurality of Hall devices located on a mounting surface to detect a magnetic field from the magnets. The magnets have heights from the mounting surface varying regularly in the rotation direction of the rotor when the rotor has a central axis extending in a vertical direction.

### RELATED APPLICATIONS

The present application claims priority to Japanese Application Number 2022-007185, filed Jan. 20, 2022, the disclosure of which is hereby incorporated by reference herein in its entirety.

### BACKGROUND

### Technical Field

The present invention relates to a motor.

### DESCRIPTION OF THE BACKGROUND

Known motors include position sensors to detect the position of a rotor. The position sensors may be optical sensors such as optical encoders or magnetic sensors such as Hall devices.

### CITATION LIST

### Patent Literature

Patent Literature 1: Japanese Patent No. 6233532

### BRIEF SUMMARY

A motor including multiple Hall devices as position sensors may estimate the position of a rotor based on the characteristics of a voltage output from each Hall device (a Hall signal).

The multiple Hall devices incorporated in the single motor are not identical to one another but vary in, for example, their dimensions, shapes, material properties, and mounting positions. Such variations cause the Hall devices to output Hall signals with different characteristics. A microcomputer may learn the characteristics of Hall signals output from the Hall devices to estimate the position of the rotor.

However, the Hall signals can have characteristics that occur randomly based on the varying characteristics of the Hall devices. Two or more Hall devices incorporated in a single motor may coincidentally have either the same or substantially the same characteristics in their output Hall signals. This may cause erroneous estimation of the rotor position.

A motor according to an embodiment includes a stator and a rotor. The rotor includes a rotor core containing a magnetic material, a plurality of magnets located on the rotor core in a rotation direction of the rotor, and a plurality of magnetic sensors located on a mounting surface to detect a magnetic field from the plurality of magnets. The plurality of magnets have heights from the mounting surface varying regularly in the rotation direction of the rotor when the rotor has a central axis extending in a vertical direction.

The motor according to the above aspect of the present invention improves the accuracy of position estimation of the rotor.

### BRIEF DESCRIPTION OF DRAWINGS

FIG. 1 is an exploded perspective view of a motor according to one embodiment.

FIG. 2 is a perspective view of the motor according to the embodiment.

FIG. 3 is a cross-sectional view of the motor according to the embodiment.

FIG. 4 is a functional block diagram of the motor according to the embodiment.

FIG. 5 is a front view of a rotor in the embodiment.

FIG. 6 is a schematic diagram showing the heights of magnets in the rotor in the embodiment.

FIG. 7A is a partially enlarged cross-sectional view of the structure showing a spatial distance between a magnet and a Hall device when they are closest to each other.

FIG. 7B is a partially enlarged cross-sectional view of the structure showing a spatial distance between another magnet and the Hall device when they are closest to each other.

FIG. 8 is a schematic diagram showing the heights of magnets in a rotor in another embodiment.

### DETAILED DESCRIPTION

An embodiment of the present invention will now be described with reference to the drawings. In the drawings used to describe the embodiment, the same reference numerals denote the same or substantially the same components. Such components will not basically be described repeatedly.

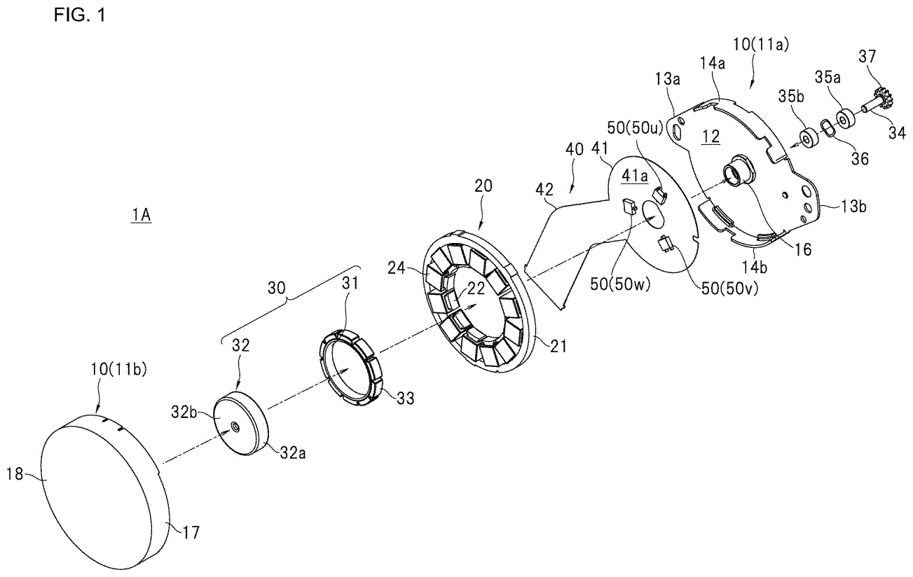

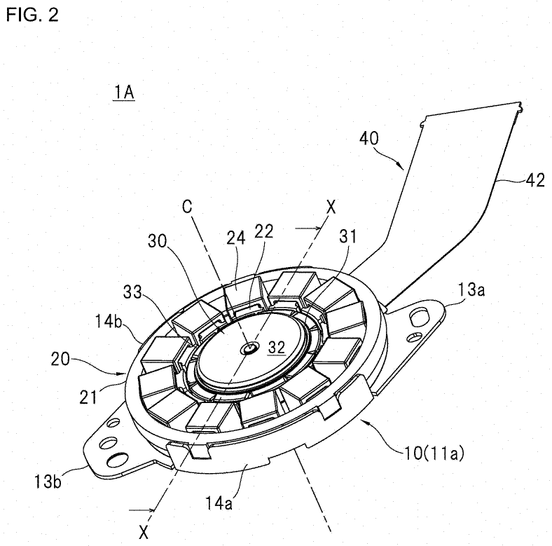

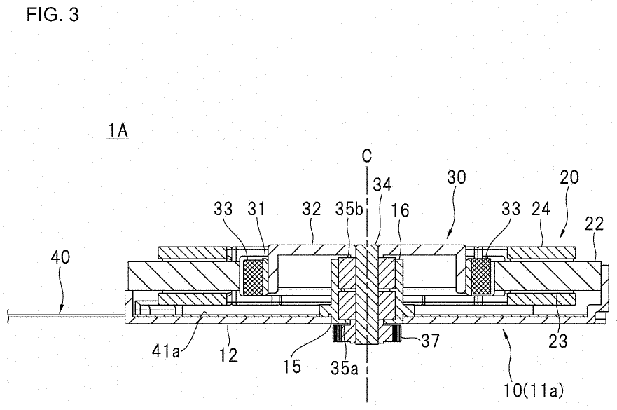

FIG. 1 is an exploded perspective view of a motor 1A according to the present embodiment. FIG. 2 is a perspective view of the motor 1A. FIG. 3 is a cross-sectional view of the motor 1A taken along line X-X in FIG. 2.

### Overview of Motor

The motor 1A includes, for example, a housing 10, a stator 20, a rotor 30, and a substrate 40. The rotor 30 and the stator 20 are housed in the housing 10. The rotor 30 is located radially inward from the stator 20 and rotatable relative to the stator 20. The motor 1A is thus an inner-rotor motor.

### Housing

The housing 10 includes two parts joined together. More specifically, the housing 10 includes a base 11a and a cover 11b. In FIGS. 2 and 3, the cover 11b is not shown. The base 11a includes a bottom wall 12, a pair of fasteners 13a and 13b, and a pair of ribs 14a and 14b.

The bottom wall 12 of the base 11a is circular or substantially circular and has a through-hole 15 at the center. A shaft holder 16 that is cylindrical and continuous with the through-hole 15 is located on the bottom wall 12 of the base 11a.

The fasteners 13a and 13b protrude parallel to the bottom wall 12 from the edge of the bottom wall 12. The ribs 14a and 14b extend perpendicularly to the bottom wall 12 from the edge of the bottom wall 12. The fasteners 13a and 13b have threaded holes to receive screws for fastening the motor 1A at a predetermined position. The ribs 14a and 14b are curved along the edge of the bottom wall 12.

The cover 11b includes a cylindrical peripheral wall 17 and a ceiling wall 18 that covers one end of the peripheral wall 17. When the base 11a and the cover 11b are combined together, the peripheral wall 17 of the cover 11b is placed outside the ribs 14a and 14b of the base 11a, and the ceiling wall 18 of the cover 11b faces the bottom wall 12 of the base 11a. The peripheral wall 17 defines an accommodation space between the bottom wall 12 and the ceiling wall 18. The accommodation space is surrounded by the peripheral wall 17 and also by the ribs 14a and 14b partially.

### Stator

The stator 20 is annular to surround the rotor 30 and is fixed inside the housing 10. The stator 20 and the rotor 30 have a predetermined clearance (air gap) between them.

The stator 20 includes a stator core 21 fixed to an inner circumferential surface of the housing 10. The stator core 21 is a stack of multiple electromagnetic steel plates. The stator core 21 includes multiple teeth 22 protruding radially inward (toward the rotor 30), or more specifically, twelve teeth 22 located at intervals of 30 degrees. In other words, the stator 20 has twelve slots.

The stator 20 includes, in addition to the stator core 21, insulators 23 surrounding the respective teeth 22, and coils 24 surrounding the respective insulators 23.

The insulators 23 are formed from an insulating material (e.g., a resin material). The coils 24 are formed from wires (e.g., copper alloy wires) wound around the insulators 23.

The twelve coils 24 include four U-phase coils, four V-phase coils, and four W-phase coils. In other words, the stator 20 receives a three-phase current with phases each shifted by 120 degrees. When energized with a current (coil current), the U-, V-, and W-phase coils 24 generate a magnetic field acting on the rotor 30.

### Rotor

The rotor 30 includes a rotor core 31, a rotor hub 32, magnets 33, and a shaft 34, and is rotatable about a central axis C as the rotation axis. The central axis C extends in a direction defined herein as a vertical direction. In this definition, the base 11a and the cover 11b included in the housing 10 face each other in the vertical direction. More specifically, the bottom wall 12 of the base 11a and the ceiling wall 18 of the cover 11b face each other in the vertical direction. For ease of explanation, a portion of the structure adjacent to the bottom wall 12 may be hereafter referred to as being lower or downward, and a portion adjacent to the ceiling wall 18 as being upper or upward. The rotation direction of the rotor 30 that rotates about the central axis C as the rotation axis may be referred to as a circumferential direction.

The rotor core 31 is formed from a magnetic material and is a cylinder extending in the vertical direction. The rotor hub 32 is located inward from the rotor core 31, and the multiple magnets 33 are located outside the rotor core 31.

The rotor hub 32 has a side surface 32a and an upper surface 32b. The side surface 32a is cylindrical and has an outer diameter smaller than the inner diameter of the rotor core 31. The upper surface 32b is disk-shaped and covers one end of the side surface 32a. The side surface 32a and the upper surface 32b are formed integrally using a non-magnetic material.

The rotor hub 32 is fitted to the inner circumference of the rotor core 31. The rotor hub 32 and the rotor core 31 are nonrotatable relative to each other. More specifically, with the inner circumferential surface of the rotor core 31 and the outer circumferential surface of the rotor hub 32 fixed to each other, the rotor core 31 and the rotor hub 32 are integral with each other.

The multiple magnets 33 are located on the rotor core 31 in the rotation direction (circumferential direction) of the rotor 30. More specifically, ten magnets 33 are located on the rotor core 31 at equal intervals. The ten magnets 33 have their N poles and S poles alternating in the circumferential direction. The magnets 33 are fixed (bonded) on the outer circumferential surface of the rotor core 31. The arrangement of the magnets 33 will be described in detail later.

The shaft 34 is fixed to the rotor hub 32. More specifically, the shaft 34 has a basal end extending through and protruding from the shaft holder 16. The basal end of the shaft 34 protruding from the shaft holder 16 is press-fitted at the center of the rotor hub 32.

The shaft 34 is supported by bearings 35a and 35b located in the shaft holder 16 in a rotatable manner. The bearing 35b is vertically stacked on the bearing 35a with a spring washer 36 between them.

The distal end of the shaft 34 extends through the bottom wall 12 of the base 11a and protrudes from the housing 10. A pinion gear 37 is attached to the distal end of the shaft 34 protruding from the housing 10.

### Substrate

The substrate 40 is a flexible substrate. The substrate 40 has a part located inside the housing 10, and another part extending outside the housing 10. For ease of explanation, the part of the substrate 40 located inside the housing 10 may be hereafter referred to as a body 41, and the other part of the substrate 40 extending outside the housing 10 may be hereafter referred to as an extension 42.

The body 41 of the substrate 40 is a disk that covers the substantially entire bottom wall 12 of the base 11a except the shaft holder 16. The extension 42 is a strip that extends between the fastener 13a and the rib 14b of the base 11a and then outside the housing 10.

### Magnetic Sensor

Multiple magnetic sensors are mounted on the substrate 40 to detect magnetic fields from the magnets 33 on the rotor 30. More specifically, three Hall devices 50u, 50v, and 50w are mounted on the substrate 40. The Hall devices 50u, 50v, and 50w are mounted on a surface 41a of the body 41 at equal intervals in the circumferential direction. In other words, the surface 41a of the body 41 is a mounting surface commonly for the three Hall devices 50u, 50v, and 50w. Thus, the surface 41a of the body 41 may be hereafter referred to as a mounting surface 41a. The Hall devices 50u, 50v, and 50w may be hereafter collectively referred to as Hall devices 50.

The Hall device 50u is a magnetic sensor for detecting the magnetic field strength of a U phase and outputs a voltage (a Hall signal or a differential signal) corresponding to the magnetic field strength of the U phase. The Hall device 50v is a magnetic sensor for detecting the magnetic field strength of a V phase and outputs a voltage (a Hall signal or a differential signal) corresponding to the magnetic field strength of the V phase. The Hall device 50w is a magnetic sensor for detecting the magnetic field strength of a W phase and outputs a voltage (a Hall signal or a differential signal) corresponding to the magnetic field strength of the W phase.

Each of the Hall devices 50u, 50v, and 50w is electrically connected to the wiring on the substrate 40. The Hall signals output from the Hall devices 50u, 50v, and 50w are input into, for example, a predetermined device, a processor, or a controller through the wiring on the substrate 40.

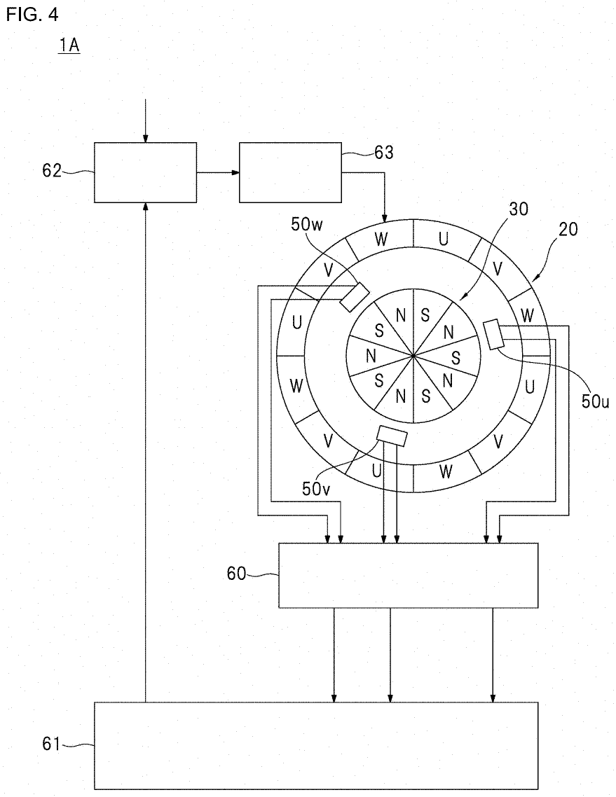

FIG. 4 is a functional block diagram of the motor 1A. The motor 1A includes an amplifier 60, a position estimator 61, a controller 62, and a drive 63. The Hall signals output from the Hall devices 50u, 50v, and 50w are input into the amplifier 60 through the substrate 40. The amplifier 60 amplifies the input Hall signals and outputs the signals to the position estimator 61.

The position estimator 61 is an information processor for estimating the position of the rotor 30. The position estimator 61 includes a calculator and a storage. The position estimator 61 estimates the position of the rotor 30 using values calculated based on the input Hall signals and information prestored in the storage, and outputs the estimation result to the controller 62. The position estimator 61 can estimate the position of the rotor 30 that may be stopped or rotating.

The controller 62 generates a control signal based on the position of the rotor 30 estimated by the position estimator 61 and an instruction signal received from an external device, and outputs the control signal to the drive 63. The instruction signal indicates, for example, the rotation direction, rotational force, rotation angle, or rotational speed of the rotor 30. The control signal indicates, for example, a register value in accordance with the rotation direction indicated by the instruction signal, or a current value of the current output from the drive 63 to the stator 20.

The drive 63 drives the stator 20 based on the input control signal. The drive 63 rotates the rotor 30 in an instructed direction at an instructed speed by, for example, supplying a three-phase current with a current value indicated by the control signal to each coil 24 of the stator 20.

### Magnet Arrangement

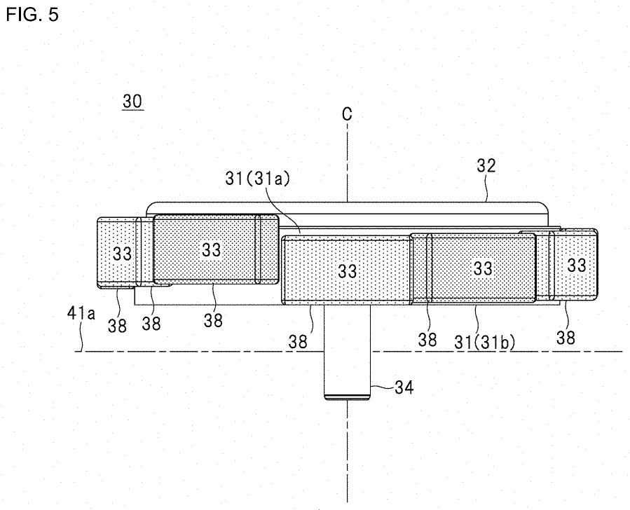

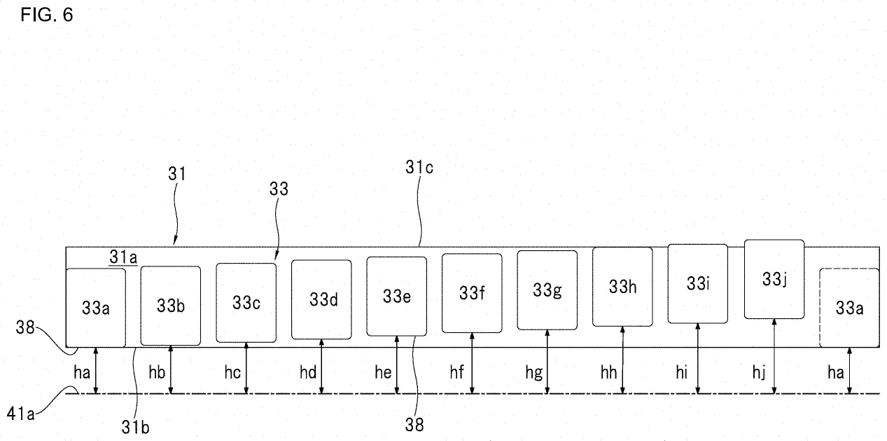

FIG. 5 is a front view of the rotor 30. FIG. 6 is a schematic diagram showing the heights of the magnets 33 from the mounting surface 41a. In other words, FIG. 6 is a development view of the rotor core 31. In FIG. 5, the pinion gear 37 is not shown.

As described above, the ten magnets 33 are located to have their N poles and S poles alternating in the circumferential direction and attached on the outer circumferential surface 31a of the rotor core 31.

The ten magnets 33 are located at constant (unchangeable) intervals in the circumferential direction. In contrast, the ten magnets 33 have different heights from the mounting surface 41a. More specifically, the heights of the ten magnets 33 from the mounting surface 41a vary regularly in the circumferential direction. The heights of the magnets 33 from the mounting surface 41a refer to the shortest linear distances from the mounting surface 41a to lower end faces 38 of the magnets 33 facing the mounting surface 41a.

For ease of explanation, the ten magnets 33 may be identified by referring to them as, for example, a magnet 33a, a magnet 33b, and a magnet 33c. The heights ha to hj of the ten magnets 33a to 33j shown in FIG. 6 gradually increase in the circumferential direction from the reference magnet 33a (ha<hb<he<hd<he<hf<hg<hh<hi<hj). More specifically, the heights ha to hj of the magnets 33a to 33j increase each by 0.02 mm in the circumferential direction. A height difference between the magnet 33a and the magnet 33j is thus 0.2 mm. In other words, the heights hj to ha of the ten magnets 33j to 33a decrease by 0.02 mm in the circumferential direction from the reference magnet 33j. In FIGS. 5 and 6, the height differences between adjacent magnets 33 are larger than the actual height differences for ease of explanation.

The lower end faces 38 of the magnets 33 have different heights from a lower end face 31b of the rotor core 31. More specifically, the lower end faces 38 of the magnets 33 have heights that gradually increase in the order of the magnets 33a, 33b, 33c, 33d, 33e, 33f, 33g, 33h, 33i, and 33j from the lower end face 31b of the rotor core 31. In other words, the lower end faces 38 of the magnets 33 have heights that gradually decrease in the order of the magnets 33j, 33i, 33h, 33g, 33f, 33e, 33d, 33c, 33b, and 33a from the lower end face 31b of the rotor core 31.

As described above, the magnets 33 have different heights that vary regularly from the mounting surface 41a on which the Hall devices 50 are mounted. Thus, the spatial distance between one magnet 33 and a Hall device 50 does not match the spatial distance between another magnet 33 and the Hall device 50.

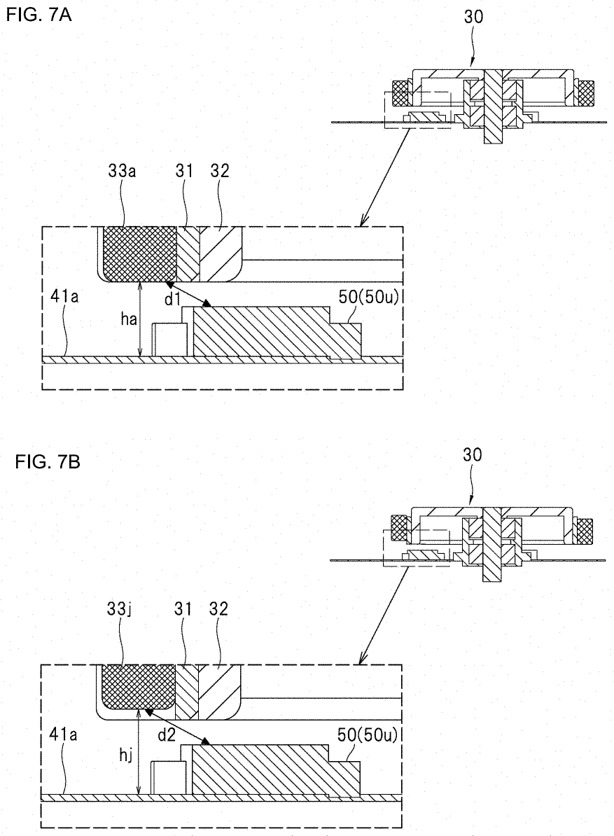

The arrangement of the magnets 33 will be further described focusing on the magnets 33a and 33j and the Hall device 50u for ease of explanation. FIG. 7A is a partially enlarged cross-sectional view of the structure showing a spatial distance d1 between the magnet 33a and the Hall device 50u when they are closest to each other. FIG. 7B is a partially enlarged cross-sectional view of the structure showing a spatial distance d2 between the magnet 33j and the Hall device 50u when they are closest to each other. Of the ten magnets 33, the magnet 33a is lowest, and the magnet 33j is highest from the mounting surface 41a (refer to FIG. 6).

A comparison between FIGS. 7A and 7B reveals a mismatch between the spatial distance d1 when the magnet 33a is closest to the Hall device 50u and the spatial distance d2 when the magnet 33j is closest to the Hall device 50u (d1<d2). Such a mismatch between the spatial distances occurs when the magnets 33a and 33j are closest to the Hall device 50u, and also in the entire area in which the Hall device 50u can detect a magnetic field. The mismatch can also occur to the other Hall devices 50v and 50w.

In the motor 1A according to the present embodiment, each magnet 33 thus generates a magnetic field with a different strength acting on the Hall devices 50. In other words, the Hall devices 50 receive a magnetic field with a different strength from each magnet 33. The Hall devices 50 output a Hall signal with a different magnitude (voltage) for each magnet 33. More specifically, when the three Hall devices 50u, 50v, and 50w incorporated in the motor 1A coincidentally have the same characteristics, the maximum and minimum values of Hall signals output from the Hall devices 50u, 50v, and 50w differ from each other for each magnet 33.

As a result, Hall signals output from two or more Hall devices 50 do not have the same or substantially the same characteristics. This improves the accuracy of position estimation of the rotor 30.

The present invention is not limited to the above embodiment, but may be modified variously without departing from the spirit and scope of the invention. For example, the arrangement (heights) of the magnets 33a to 33j shown in FIG. 6 is an example and may be changed as appropriate. In FIG. 6, the magnets 33i and 33j protrude upward from an upper end face 31c of the rotor core 31. However, all the magnets 33a to 33j may be arranged within the height range of the rotor core 31 (between the lower end face 31b and the upper end face 31c). One or more magnets 33 may protrude downward from the lower end face 31b of the rotor core 31. The height differences between adjacent magnets 33 may also be changed as appropriate.

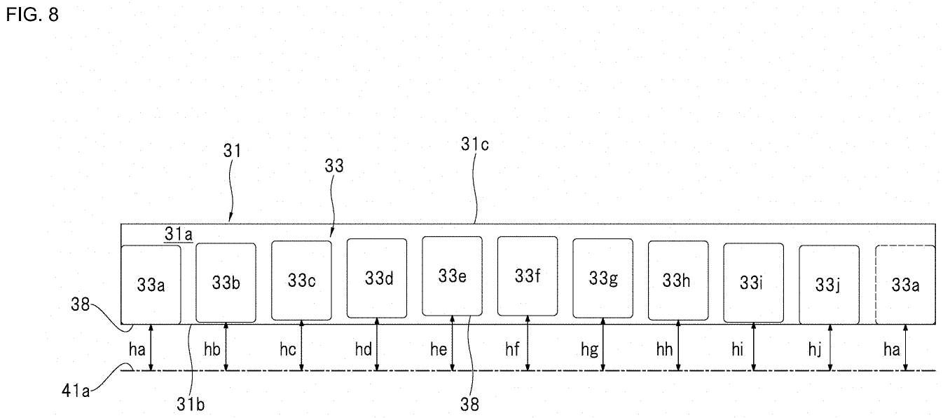

The arrangement (heights) of the magnets 33a to 33j may be based on regularity different from the regularity described above. FIG. 8 shows an example arrangement of the magnets 33a to 33j with their heights varying based on different regularity.

In FIG. 8, the magnets 33e and 33f in the middle are arranged at the same height that is highest from the mounting surface 41a (he=hf). The magnets 33a and 33j at both ends are arranged at the same height that is lowest from the mounting surface 41a (ha=hj). The heights of the magnets 33b, 33c, and 33d arranged between the magnets 33a and 33e gradually increase (by 0.02 mm) toward the magnet 33e (hb<hc<hd). In contrast, the heights of the magnets 33g, 33h, and 33i arranged between the magnets 33f and 33j gradually decrease (by 0.02 mm) away from the magnet 33f (hg>hh>hi).

In FIG. 8, the magnets 33a to 33j are arranged symmetric to one another (to have symmetric heights). More specifically, five sets (five pairs) of magnets 33 with the same height are arranged on the rotor core 31. The example structure shown in FIG. 8 has lower accuracy in estimating the position of the rotor 30 than the example structure shown in FIG. 6. However, the example structure shown in FIG. 8 can estimate the rotor position more accurately than an example structure including magnets 33 arranged at the same height.

The numbers of teeth 22, magnets 33 and Hall devices 50 may be changed as appropriate. FIG. 4 shows mere examples of the functional blocks, in which Hall signals may be input into components other than the amplifier 60.

What is claimed is:

1. A motor, comprising:
a stator; and
a rotor including
a rotor core comprising a magnetic material,
a plurality of magnets located on the rotor core in a rotation direction of the rotor, and
a plurality of magnetic sensors located on a mounting surface to detect a magnetic field from the plurality of magnets,
wherein the plurality of magnets have heights from the mounting surface varying regularly in the rotation direction of the rotor when the rotor has a central axis extending in a vertical direction.

2. The motor according to claim 1, wherein
the plurality of magnets have heights from the mounting surface gradually increasing or decreasing in the rotation direction of the rotor.

3. The motor according to claim 1, wherein
the rotor further includes a rotor hub comprising a non-magnetic material,
the rotor has an inner circumferential surface fixed on an outer circumferential surface of the rotor hub, and
the plurality of magnets are fixed on an outer circumferential surface of the rotor core.

4. The motor according to claim 1, further comprising:
a position estimator configured to estimate a position of the rotor based on a signal output from the plurality of magnetic sensors.
